(19) United States
(12) Patent Application Publication
(10) Pub. No.: US 2002/0099693 A1
(43) Pub. Date: Jul. 25, 2002

(54) Method and apparatus for performing automated trademark and domain name correlation

(76) Inventor: Tev Kofsky, Montreal (CA)

Correspondence Address: DOWELL & DOWELL, P.C., Suite 309, 1215 Jefferson Davis Highway, Arlington, VA, 22202, US

(21) Appl. No.: 09/726,488

(22) Filed: Dec. 1, 2000

(51) Int. Cl. G06F 7/00

(52) U.S. Cl. 707/3

(57) ABSTRACT

A method for performing domain name information and trademark information analysis. The method includes prompting a user to enter a name on which a search is to be conducted and then formulating a query request directed to remote databases containing domain name information and trademark information. The response received to the query request is processed and displayed to the user. The method allows detection of questionable Internet practices such as typopiracy, cybersquatting and bad faith.

### FIELD OF THE INVENTION

The invention relates to a method and to an apparatus for automatically querying databases to extract trademark information and/or domain name registration information. The invention finds practical applications in identifying registration domain names that are identical or confusing with registered trademarks and/or with other registered domain names. The invention can also be used for identifying names for which trademark and/or domain names registrations are available.

### BACKGROUND OF THE INVENTION

The Internet allows access to many databases that provide information on registered trademarks, in particular, trademark ownership details. Among these databases are the USPTO (United States Patent and Trademark Office) and CIPO (Canadian Intellectual Property Office).

Also available to the public are Internet sites which provide information on Domain name registration and/or ownership. Some examples are www.nsi.com, www.internic.net and www.internic.ca. A common name for the database sites, which produce domain name ownership information, is “WHOIS”.

In the present specification, the following definitions apply:

1. “BOT” implies an automated software implemented agency that can access Internet sites and retrieve data;

2. “WHOIS” A database containing Domain name registration and/or ownership details;

3. “DATABASE” refers to a database that provides information on registered trademarks, in particular, trademark ownership details or to a database containing Domain name registration and/or ownership details. CIFO, USPTO and WHOIS are considered to be databases;

4. “REGISTRANT” person or entity which has registered a Domain or Trademark;

5. “NAME” refers to registered trademarks, product names and domain names;

6. OWNER” the rightful owner of a NAME;

7. “OTHERS” A term used to indicate a person other then the OWNER;

8. “PRODUCT” name refers to a name that an “OWNER” has not registered as trademark or registered as a domain name;

9. “PARKED” an Internet site accessible under a domain name that has been registered but the site has not yet been activated;

10. “FOR SALE” an Internet Domain name that has been registered and is being offered for sale;

11. “CONSTRUCTION” an Internet Site that has posted a message stating that it is under construction;

12. “STATUS” indicates whether an Internet site is under construction, for sale , parked or active;

13. “META TAGS” is information hidden from view in an Internet site. Typically, Search engines use these words to classify the site;

14. “KEYWORDS” information used in an Internet site that describe the site. This information may be in the form of meta tags or information in another form, for example words that are apparent to the visitor of the site;

15. “BAD FAITH” term indicating that a NAME was registered for the purpose of being sold or to divert business by having a close spelling to that of an existing Domain name, where the NAME is registered by an entity of person other than the owner of the domain name;

16. “BAD FAITH ANALYSIS” analysis for finding the registrant of a Domain name and then searching for any other domain name that this registrant may have registered. Optionally, the status of the sites under the located domain names is also investigated. This information is used to determine the history and intent of the registrant;

17. “CONFLICT” refers to any of the following combinations.

| | | |
|---|---|---|
| 1. OWNER trademark | vs | OTHER trademarks |
| 2. OWNER trademark | vs | OTHER domain names |
| 3. OWNER Domain name | vs | OTHER trademarks |
| 4. OWNER Domain name | vs | OTHER Domain names |
| 5. OWNER Product name | vs | OTHER trademarks or |
| | | Domain names. |

The use of the Internet for e-commerce has produced three areas of questionable business tactics, namely:

1. Cybersquatting.

Here an individual has registered a domain name using the trademark registered by another with the intent to later sell the Domain name to the original trademark owner.

### EXAMPLE

Consider the famous trademark “ABC”. If the owner of the mark has not registered a Domain name www.abc.com then any person can do so. These being done in the hope that the company “ABC” will offer a substantial amount of money to the registrant to purchase the name. Consider also the situation whereby ABC has registered the name www.abc.com. A Cybersquatter could register www.abc-europe.com again hoping to sell the domain name back to ABC.

2. Typopiracy.

In this case an individual has registered a Domain name with a slight variation in spelling from that of a competitor. The individual hopes to capitalize on spelling errors to divert a customer to his site.

### EXAMPLE

Consider the registered name www.baby.com, which is a fictitious store for baby clothing. A typopirate could register a name www.babie.com This individual could operate a baby clothing store and capitalize on typo errors to divert business to his site.

3. Meta Tag and Keywords.

In this case the individual has hidden his competitor trademarks or keywords in Meta Tags. If a potential customer uses a search engine to look for a particular product or service he may be diverted to a competitor.

### EXAMPLE

Consider the case where an individual hides the name “baby clothing” in his meta tags. A user using a search engine to find the “baby.com” site would receive a list of sites that relate to “baby”. Amongst them would be the pointer to a competitive Domain.

At the present time an individual who wants to perform a correlation between a registered trademark and registered domain names must manually access a database then type the name to be searched. This must be repeated for each database of interest. For example a user would have to manually access the USPTO, CIPO and the pertinent WHOIS site. In some cases the WHOIS site accessed may not contain the required information and the USER would then have to try another WHOIS site.

In the case of a search involving multiple spellings the individual would have to repeat the search for each spelling variation. Some sites allow for the use of wild cards to effect a multiple spelling search. However, this search facilitation is not consistent among different databases and the user must accommodate this.

After all the sites and spelling combinations have been searched the user then correlates the results by hand and manually types a report.

As an illustration consider a search for the name “copitrak”. Copitrak can be spelled with either a c, k, or ck. Also the middle letter “i” can be replaced by a “y”. The search would involve six names. Since the Domain names have four suffixes of interest that is com, net, org, ca and at least two possible trademark registrations that is CIPO and USPTO the total number of searches could amount to thirty six. This only returns ownership information. To obtain the status of these site would require twenty-four site visits. Total number of access now equals sixty.

To do a wild card search, that is, look for sites that have the following pattern www.e-copitrak.com or www.copitrak-europe.com where the search is done as follows *copitrak* etc would increase the number of accesses.

Against this background it appears that a need exists in the industry to provide a method and an apparatus for performing correlation between trademark information and domain name information that avoids or at least alleviates the disadvantages associated with prior art techniques.

### SUMMARY OF THE INVENTION

Under a broad aspect, the invention provides a method for performing trademark and domain name information analysis. With this method the user is prompted under control of a client system to enter information about a certain name. The name may be a registered trademark, a registered domain name or a name that is neither a registered trademark nor a registered domain name. On the basis of the information entered by the user, a query request is formulated and sent by the client system to at least one database containing trademark information and to at least one database containing domain name information. The responses to the query requests are received and processed by the client system. Next, the client system displays to the user trademark information related to the name, associated with domain name information also related to the name.

This method is beneficial by its ability to seek and obtain automatically by the client system responses to the queries made at the trademark and domain name databases and also to process and correlate the information in the responses such that trademark information related to a given name is associated with domain name information also related to the name.

Optionally, the method allows formulating query requests based on variations in the spelling of the certain name. For example, the user may indicate alternative spelling of the name or use wildcard characters. The query formulation then includes the step of breaking down the entry of the user into a plurality of search inquiries, each inquiry corresponding to a certain spelling of the name.

Under a second broad aspect, the invention provides a method for performing domain name information analysis. With this method the user is prompted under control of a client system to enter information about a certain name owned by a certain entity. The name may be a registered trademark, a name that is neither a registered trademark nor a registered domain name, or a registered domain name. On the basis of the information entered by the user, a query request is formulated and sent by the client system to at least one database containing domain name information. The query request is a message to extract from the domain name information database domain names that are similar to the certain name entered by the user. The response to the query request is received and processed by the client system. The processing includes a filtering function allowing displaying to the user the name owned by the certain entity versus domain names owned by entities that belong to group of entities excluding the certain entity owning the name.

Under a third broad aspect, the invention provides a method for performing trademark information analysis. With this method the user is prompted under control of a client system to enter information about a certain name owned by a certain entity. The name may be a registered trademark, a name that is neither a registered trademark nor a registered domain name, or a registered domain name. on the basis of the information entered by the user, a query request is formulated and sent by the client system to at least one database containing trademark information. The query request is a message to extract from the trademark information database registered trademarks that are similar to the certain name entered by the user. The response to the query request is received and processed by the client system. The processing includes a filtering function allowing displaying to the user the name owned by the certain entity versus domain names owned by entities that belong to group of entities excluding the certain entity owning the name.

The invention also provides a computer readable storage medium containing a program element for execution by a computing device, the program element implementing the method under the first broad aspect of the invention.

The invention also provides a computer readable storage medium containing a program element for execution by a computing device, the program element implementing the method under the second broad aspect of the invention.

The invention also provides a computer readable storage medium containing a program element for execution by a computing device, the program element implementing the method under the third broad aspect of the invention.

### BRIEF DESCRIPTION OF THE DRAWINGS

A detailed description of examples of implementation of the present invention is provided hereinbelow with reference to the following drawings, in which:

FIG. 1 is a block diagram of a network arrangement allowing a client system to retrieve domain name and trademark information from remote databases;

FIG. 2 is block diagram of the client system;

FIG. 3 is a functional block diagram of the program element executed on the client system; and

FIGS. 4 to 10 are representations of Graphical User Interfaces (GUI) that illustrate the functionality of the program element executed by the client system.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

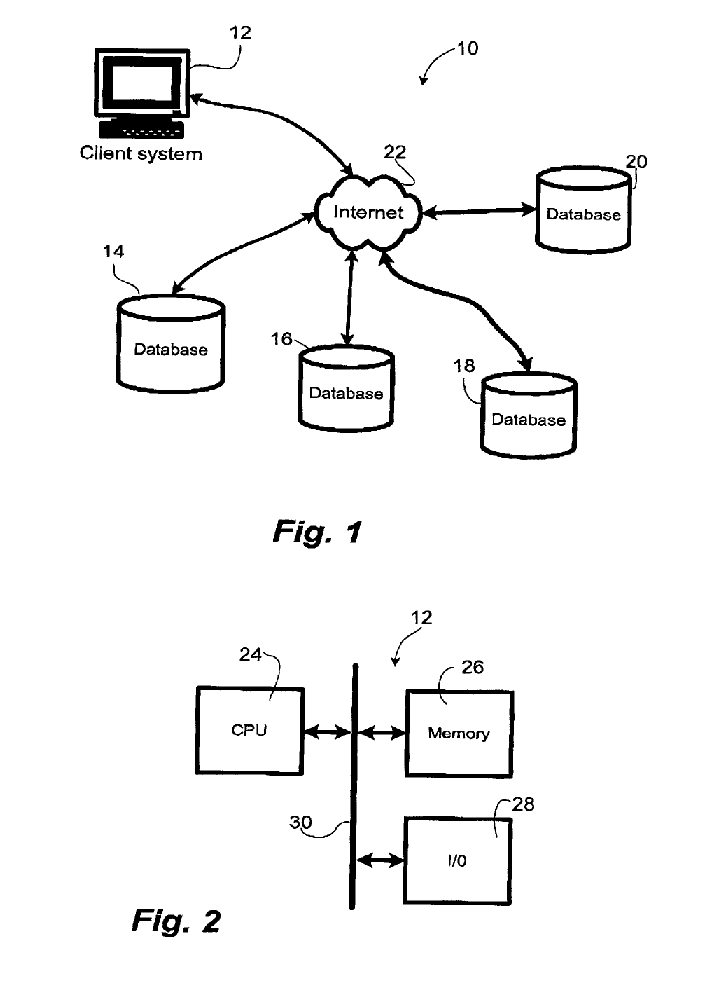

FIG. 1 illustrates a network arrangement 10 comprising a client system 12 that communicates with a plurality of databases 14-20 through the Internet 22. Some of the databases 14-20 contain registered trademark information. Possible examples include the database operated by the United States Patent and Trademark Office and the database operated by Canadian Intellectual Property Office. Some of the databases 14-20 also contain registered domain name information. Examples include the databases at the following sites: www.nsi.com, www.internic.net and www.iternic.ca.

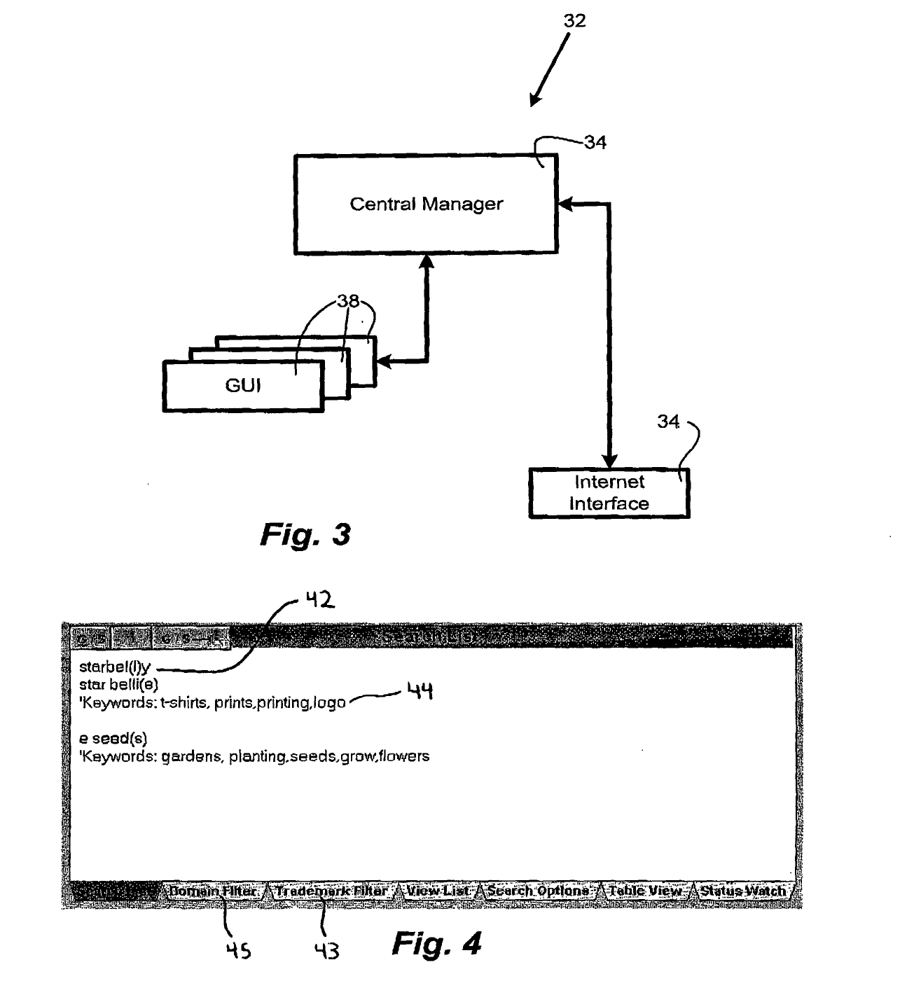

The client system 12 is illustrated in greater detail at FIG. 2. The client system includes a Central Processing Unit 24, a memory 26, an Input/Output (I/O) interface 28 and a data bus 30. The memory contains a program element that is executed by the CPU 24 to donate to the client system 12 a functionality that will be described in detail later. The I/O port 28 is the agency through which the CPU 24 communicates with the external world. The data bus 30 allows the components of the client system 12 to exchange messages between them.

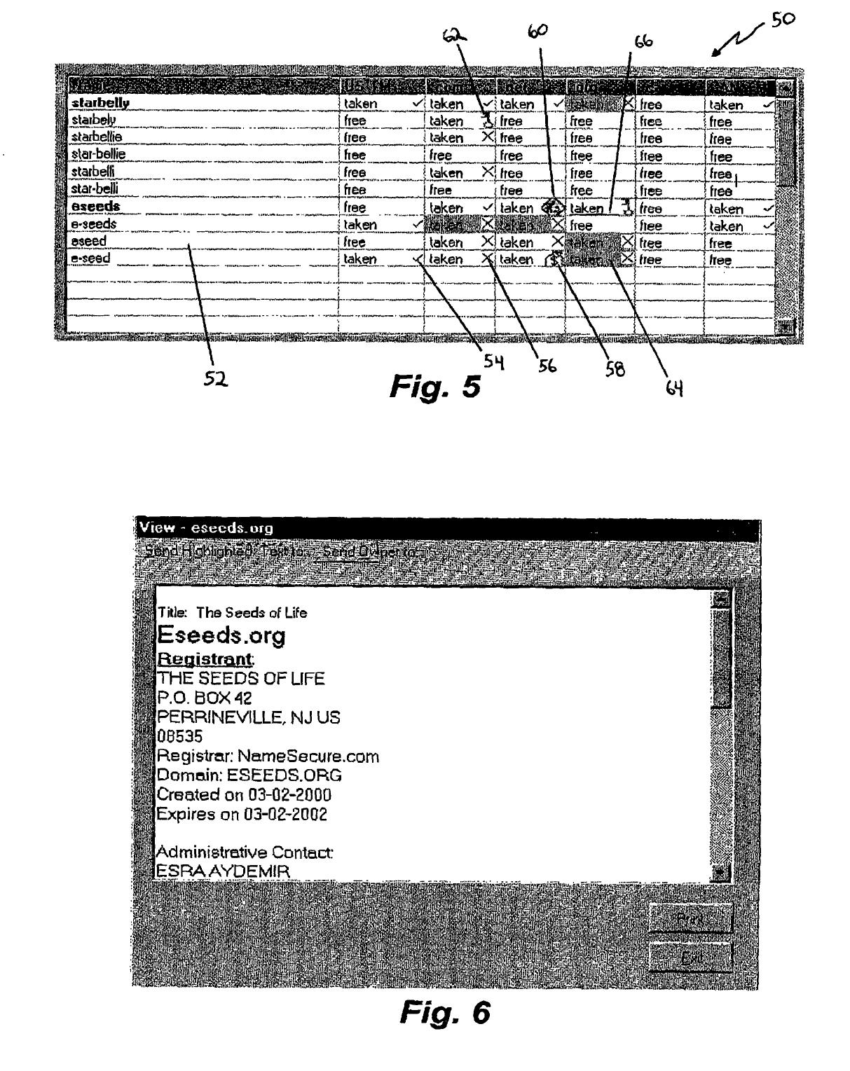

The architecture of the program element 32 is illustrated at FIG. 3. The program element 32 has a central manager 34 that is responsible for the overall control and processing done by the program element 34. A set of GUIs 38 communicate with the central manger 34. The GUIs 38 display information to the user on a monitor (not shown) and also constitute an agency through which the user can input data to the central manager 34.

Finally, the program element 32 also includes an Internet Interface 34 through which messages exchanged between the central manager and the databases 14-20 transit.

The functionality of the program element 34 will now be described.

Typopiracy Search

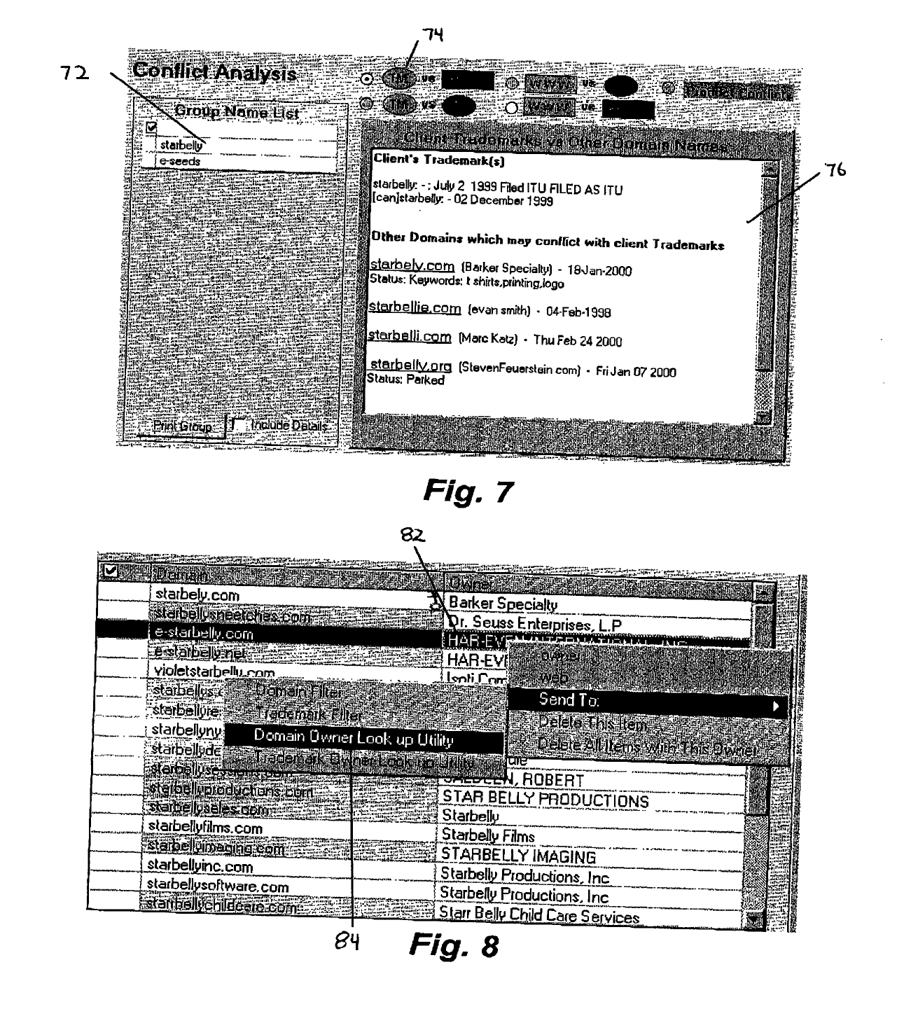

In order to initiate a typopiracy search, the user enters name for which an analysis is required through a GUI shown in FIG. 4. As shown, the user is not restricted to inputting precise names 42 since the program entity 32 allows for variations due to spelling as well as variations due to prefixes and suffixes by respectively allowing the use of shorthand and wildcards. This enables the generation of a plurality of search inquiries that include all permutations of that name. FIG. 4 further shows that below each name 42, the user may, by clicking on an appropriate icon, input different keywords 44 that are particular to the name being checked. For example, these could be trademarks wares or services or terms that have been advertised and have become associated with a particular site or descriptions of the products or services offered. Note that variants of a similar name, such as starbel(l)y and star belli(e) in FIG. 4 for example, can be grouped together one directly below the other. Although FIG. 4 shows that only two groups of names have been input into the GUI text pad input screen, it should be expressly understood that any number of groups of names can be input by the user. The user can also enter the name of the entity (such as the owner, for example) for whom the search is being performed via domain or trademark filters 26, 28. Those filters are accessible by clicking the tabs 45 and 43 respectively. This will enable the user to identify a given trademark or domain name as being owned or affiliated with the owner for which the search is being conducted.

Once the proper data has been input into the search list, the user then generates a search report by clicking on a search button (not shown) thereby allowing the Central manager module 34 to formulate the query request. In doing so, the central manager module 34 will expand the list of names to include all the spelling variations defined by the shorthand and the wildcards, thus generating a plurality of search inquiries each corresponding to spelling variation. The search inquires are then sent by the Interface module 34 through the Internet 22 to one or more of the databases 14-20 that contain registered trademark information and registered domain name information. Upon reception of these results through the Internet interface 34, the data is processed by the central manager and placed into a typopiracy GUI such as that depicted in FIG. 5.

FIG. 5, more specifically, shows a GUI having a main table 50 containing the expanded list of names 52 for each group that was specified in relation with FIG. 4 as well as any pertinent ownership information for all related registered domain names and registered trademarks. Moreover, each cell of the main table 50 will indicate whether or not the trademark or domain is “taken” or “free”. The cells which are marked as taken will further display either a check mark 54 or an “x” 56. The check mark 54 indicates that the name is owned by the owner; ownership having been defined by entries into the domain and trademark filters 26, 28 as defined previously. Additional pertinent information returned by the database in response to the query, is status information on the various sites. The status information is in the form of various icons, is also contained within the relevant cell. More specifically, main table 50 in FIG. 5 also displays the operational status of the site under the registered domain name. In the example shown, one cell contains an icon, such as a money bag 58 which implies that the Internet domain name has been registered and is for sale. Another icon contains a construction sign 60 implying that that specific Internet site is under construction. A key 62, on the other hand, indicates that the associated site contains one or more of the keywords that were specified by the user initially. A darkened cell 64 reveals that the site is parked while a line 66 indicates that the site has meta tags in common with the owner's site. Although specific icons are described above, it should be expressly understood that any icon, symbol, and the like can be used without departing from the spirit of the invention.

The user can also, by clicking on a desired cell, generate more detailed information (i.e, registrant, contacts, etc.) on a particular domain, as shown by the GUI of FIG. 6. This is particularly useful in cases where the owner owns, or is affiliated with, other domains that were not registered under his or her name. In such cases, the user can send these domains into the domain filter 45 and, as a result, the corresponding cells in the main table 50 will thereafter be marked accordingly with a check mark 54. The user can also view more detailed information pertaining to a given trademark by clicking on the appropriate cell. Moreover, the user can also generate a list containing other similar trademarks (not shown). once again, the program allows for situations in which the owner owns, or is affiliated with, other trademarks that were not registered under his or her name. In such cases, the user simply sends these trademarks into the trademark filter 48 and, as a result, the corresponding cells in the main table 50 will thereafter be marked with a check mark 54.

At any time during the course of this stage, the user can generate a conflict analysis or a bad faith analysis by clicking on the appropriate buttons. Both analyses are described below with reference to subsequent figures.

Conflict Analysis

FIG. 7 illustrates the GUI of a conflict analysis. As shown, a portion of the screen contains a list of the names 72 being analyzed; the latter being the same which were specified with respect to FIG. 4 and which were used during the course of the typopiracy search. The user need only click the specific name for which the analysis is required. Another portion of the screen, designated by the reference numeral 54, enumerates the five different types of analyses that can be done. These five types, which were described in greater detail in the background, include: owner trademark versus other trademarks, owner trademark versus other domain names, owner domain name versus other trademarks, owner domain name versus other domain names, and owner product name versus other trademarks or domain names. The third and final portion of the screen contains the actual results of the conflict analysis 76.

Bad Faith

FIG. 8 shows the GUI of the menu that allows the user to perform a bad faith analysis. As shown, as in the main table 50, if a domain or trademark is recognized as being owned or affiliated with the owner, it may be added to the domain filter 45 or trademark filter 43 respectively. Alternatively, the user may instruct the BOTS to search for all domains registered to a specific registrant by highlighting the cell 82 associated with that same registrant and clicking on the appropriate button 84. As a result, the bad faith module, described hereinafter is invoked.

FIG. 9 shows the GUI of the bad faith module. As shown, the name of the registrant being investigated, as specified in connection with FIG. 8, is shown on a portion of the screen 92. An adjacent portion of the screen 94 shows all the domains registered by the registrant under investigation. Thus, the user can visually assess the specified registrant's domain name registering strategy.

Cybersquatting

In order to conduct a cybersquattirig search, the user clicks on the appropriate button and a GUI such as that shown in FIG. 10 is obtained. By clicking on an appropriate menu, the user can access a text entry box (not shown) where the name or names on which searches are to be conducted can be entered. As described in relation with the typopiracy module, the user is not required to input specific or precise names since the program allows for variations due to spelling as well as variations due to prefixes and suffixes by respectively allowing the use of shorthand and wildcards. Moreover, the user can input any number of names as well as associated keywords for each. Each group in the text box is then represented by a name in a group list 102. At this point, the user specifies a given group by clicking on it and thereby placing a check mark adjacent to it. A regular search or a search including keywords/meta tag information can then be conducted by clicking on the appropriate icons. The results are tabulated and displayed on an adjacent portion of the screen. More specifically, FIG. 10 shows the domain names 104 returned by the BOTS as well as their respective registrants 106. The status of each site 108 (i.e., parked, for sale, etc.) is also displayed via the use of icons such as those described previously.

Once the results of the analyses detailed hereinabove are obtained, they can be forwarded to a report module.

Although various embodiments have been illustrated, this was for the purpose of describing, but not limiting, the invention. Various modifications will become apparent to those skilled in the art and are within the scope of this invention, which is defined more particularly by the attached claims.

1) A method for performing trademark and domain name information analysis, comprising:
a) under control of a client system prompting a user to enter information about a name;
b) formulating a query request on the basis of the information entered by the user;
c) sending the query request to at least one remote database containing trademark information and to at least one remote database containing domain name information;
d) receiving a response to the query request from the at least one database containing trademark information and a response to the query request from the at least one database containing domain name information;
e) processing the responses and displaying to the user trademark information related to the name, associated with domain name information related to the name.

2) A computer readable storage medium containing a program element for execution on a computing device for implementing a method comprising:
a) prompting a user to enter information about a name;
b) formulating a query request on the basis of the information entered by the user;
c) sending the query request to at least one remote database containing trademark information and to at least one remote database containing domain name information;
d) receiving a response to the query request from the at least one database containing trademark information and a response to the query request from the at least one database containing domain name information;
e) processing the responses and displaying to the user trademark information related to the name, associated with domain name information related to the name.

3) A method for performing domain name information analysis, comprising:
a) prompting a user under control of a client system to enter information about a certain name owned by a known entity;
b) formulating a query request on the basis of the information entered by the user;
c) sending the query request under control of the client system to at least one database containing domain name information, the query request prompting the database to return registered domain names that are similar to the certain name entered by the user;
d) receiving the response to the query request by the client system;
e) processing the response received including filtering the response for displaying to the user the name owned by the certain entity versus domain names owned by entities that belong to group of entities excluding the certain entity owning the name.

4) A computer readable storage medium containing a program element for execution by a computing device for implementing the method, comprising:
a) prompting a user to enter information about a certain name owned by a known entity;
b) formulating a query request on the basis of the information entered by the user;
c) sending the query request to at least one database containing domain name information, the query request prompting the database to return registered domain names that are similar to the certain name entered by the user;
d) receiving the response to the query request;
e) processing the response received including filtering the response for displaying to the user the name owned by the certain entity versus domain names owned by entities that belong to group of entities excluding the certain entity owning the name.

5) A method for performing trademark information analysis, comprising:
a) prompting a user under control of a client system to enter information about a certain name owned by a certain entity;
b) formulating a query request under control of the client system on the basis of the information entered by the user;
c) sending the query request under control of the client system to at least one database containing trademark information for prompting the database to return a list of registered trademarks that are similar to the certain name entered by the user;
d) receiving the response to the query request;
e) processing the response by the client system including filtering the response and displaying to the user under control of the client system the name owned by the certain entity versus registered trademarks owned by entities that belong to group of entities excluding the certain entity owning the name.

6) A computer readable storage medium containing a program element for execution by a computing device for implementing a method, comprising:
a) prompting a user to enter information about a certain name owned by a certain entity;
b) formulating a query request on the basis of the information entered by the user;
c) sending the query request to at least one database containing trademark information for prompting the database to return a list of registered trademarks that are similar to the certain name entered by the user;
d) receiving the response to the query request;
e) processing the response including filtering the response and displaying to the user the name owned by the certain entity versus registered trademarks owned by entities that belong to group of entities excluding the certain entity owning the name.
